(19) United States
(12) Patent Application Publication
(10) Pub. No.: US 2025/0129643 A1
(43) Pub. Date: Apr. 24, 2025

(54) Adjustable Corner Drive Assembly For Window Locking System

(71) Applicant: ASSA ABLOY Fenestration, LLC, Rochester, NY (US)

(72) Inventor: Eric RODEMS, Spencerport, NY (US)

(73) Assignee: ASSA ABLOY Fenestration, LLC, Rochester, NY (US)

(21) Appl. No.: 18/887,535

(22) Filed: Sep. 17, 2024

Related U.S. Application Data
(60) Provisional application No. 63/545,444, filed on Oct. 24, 2023.

(51) Int. Cl. E05C 1/06; E05C 1/00; E06B 3/38

(52) U.S. Cl. CPC E05C 1/06; E05C 1/004; E06B 3/38

(57) ABSTRACT

A corner drive assembly for a window locking system installed in a projection-style window and co-operable with a window operator generally includes a case or body assembly, a lower adjustment bar assembly, a corner transfer spring, and an upper adjustment bar assembly. The corner drive assembly provides adjustability during installation integrate with the window locking system. The corner drive assembly is adaptable for installation in a window requiring either a surface mount installation configuration or a Euro-groove installation configuration.

### CROSS-REFERENCE TO RELATED APPLICATION

This application claims the benefit of U.S. Provisional Application No. 63/545,444, filed on Oct. 24, 2023. The entire disclosure of the above application is incorporated herein by reference.

### FIELD

The present disclosure relates to a corner drive assembly for a window locking system, such as may be included in a vent operator for a projection-style window assembly, such as an awning window, or a casement-style window assembly.

### BACKGROUND

This section provides background information related to the present disclosure which is not necessarily prior art.

Vent operators, like that disclosed in International Patent Application Publication No. WO 2016/037186 A1 entitled “Vent Operator”, are known to be employed in casement-style or projection-style window assemblies, including awning windows. Vent operators may also include a locking system. The locking system may include multiple lock points. For example, a window assembly may include lock points at the bottom, side and top of the window sash and/or frame. Vent operator locking systems may also include one or more corner drive assemblies for transferring load and motion around a corner of a window sash or frame to operate the locking systems, such as is disclosed in U.S. Pat. No. 10,648,206 entitled “Corner Drive Assembly for Window Locking System,” the disclosure of which is incorporated herein by reference in its entirety. Thus, vent operator locking systems can transfer movement of a horizontal lock bar through the corner drive assembly and correspondingly move a vertical lock bar and/or lock pin, or a vertical lock bar through the corner drive assembly and correspondingly move a horizontal lock bar and/or lock pin.

### SUMMARY

This section provides a general summary of the disclosure, and is not a comprehensive disclosure of its full scope or all of its features.

The present disclosure provides a corner drive assembly for a window locking system installed in a projection-style or a casement-style window assembly and co-operable with a window or vent operator. The corner drive assembly is mounted to a window frame. The corner drive assembly provides adjustability and can be modified during installation to allow the corner drive assembly to be readily integrated within the window locking system, even when the window locking system and its components vary, to accommodate installation in windows of different sizes and styles.

In one aspect of the disclosure, the present disclosure provides an adjustable corner drive assembly. The corner drive assembly is installed in a window frame and integrated with a window locking system. The corner drive assembly generally includes a case or body assembly, a lower adjustment bar assembly, a corner transfer spring, and an upper adjustment bar assembly.

In another aspect of the disclosure, certain dimensional characteristics of the corner drive assembly are variable so the corner drive assembly is universally adaptable for integration with window locking systems designed for installation in windows of different sizes and styles.

In another aspect of the disclosure, the overall lengths of each of the upper and lower adjustment arm assemblies can be modified at installation to adapt the corner drive assembly to the locking system.

In another aspect of the disclosure, the adjustability (within an adjustment range) is infinite. Therefore, the corner drive assembly can be standardized and still capable of being integrated with different window locking systems having components sized for installation in a variety of window sizes and styles.

In another aspect of the disclosure, the corner drive assembly is adaptable for installation in a window requiring either a surface mount installation configuration or a Euro-groove installation configuration.

Further areas of applicability will become apparent from the description provided herein. The description and specific examples in this summary are intended for purposes of illustration only and are not intended to limit the scope of the present disclosure.

### DRAWINGS

The drawing figures provided herein are for illustrative purposes for specific embodiments and implementations of the disclosure. Not all possible implementations are disclosed, therefore, the drawing figures are not intended to limit the scope of the present disclosure.

FIG. 1 is a front-top-right perspective view of a vent window assembly including a window locking system having a corner drive assembly according to the principles of the present disclosure;

FIG. 2 is an enlarged detail of a portion of FIG. 1 particularly illustrating the corner drive assembly as installed in the vent window assembly and part of the window locking system;

FIG. 3 is a front-top-right perspective view of a corner drive assembly according to the principles of the present disclosure;

FIG. 4 is an exploded front-top-right perspective view of the corner drive assembly of FIG. 3;

FIG. 5 is a detail view of an outer adjustment bar for a corner drive assembly according to the principles of the present disclosure and showing a bottom perspective view of the outer adjustment bar;

FIG. 6 is a front-top-right perspective view of a corner drive assembly according to the principles of the present disclosure and showing uper and lower adjustment bar assemblies with the respective inner adjustment bars in an extended position;

FIG. 7 is a top-right perspective view of a corner drive assembly according to the principles of the present disclosure showing a euro-groove-mount configuration;

FIG. 8 is a top-right perspective view of a corner drive assembly according to the principles of the present disclosure showing a surface-mount configuration; and

FIG. 9 is a top plan view of a track of the corner drive assembly according to the principles of the present disclosure showing a euro-nut double screw slot.

As applicable, corresponding reference numerals indicate corresponding parts throughout the several views of the drawings.

### DETAILED DESCRIPTION

Example embodiments will now be described more fully with reference to the accompanying drawings. These example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

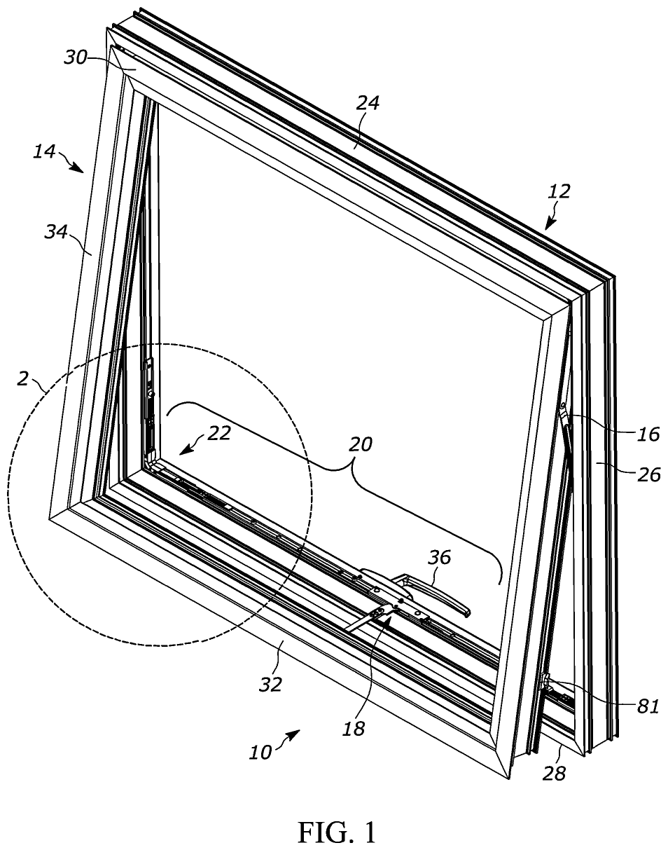

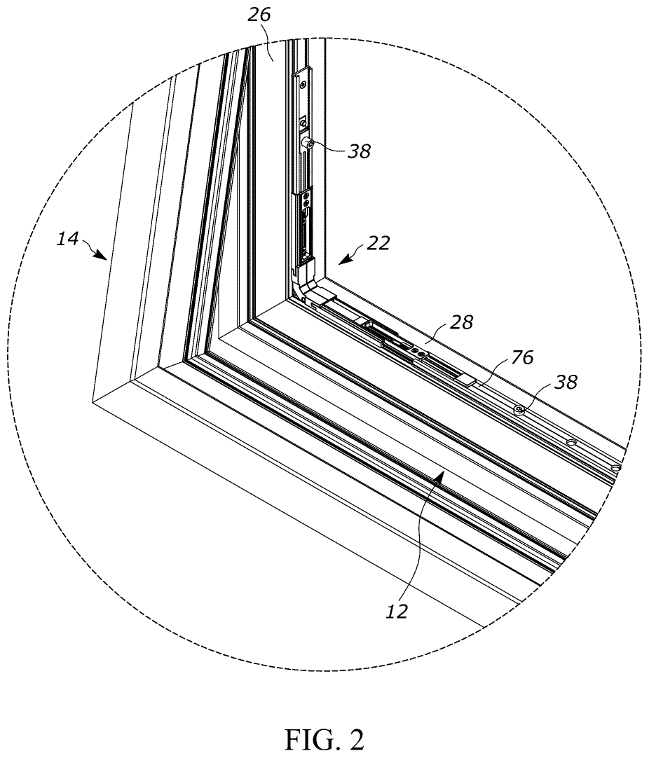

Referring now to the drawings and particularly FIGS. 1 and 2, a vent window assembly 10 is shown. As illustrated in the figures, the vent window assembly 10 is an awning-type, projection window and includes a window frame 12, a window sash or vent 14, a pair of hinges 16, a vent operator 18 and a window locking system 20 including the corner drive assembly 22 according to the present disclosure. While an awning-type window assembly is shown, it can be appreciated that the present disclosure is applicable to other types of projection window assemblies, such as a hopper-type window or a casement-type window, for example.

The window frame 12 is shown to be rectangular and having the components of a head frame or head jamb 24, two side jambs 26, (i.e., a left side jamb and a right side jamb), and a base frame 28. Similarly, the vent is likewise illustrated to be rectangular and includes a frame constructed from the components of two horizontal rails (e.g., a top rail 30 and a bottom rail 32) and two vertical stiles 34 (e.g., a left stile and a right stile). The window frame 12 and vent frame components can be manufactured from plastic, metal or wood and can be extruded or milled from stock. The frame components, and particularly the window frame 12 components, possess cross-sectional geometries, features and/or profiles that may accommodate the installation of the hinges 16, vent operator 18, window locking system 20, and their respective components, as well as other components of the window assembly, like weather-stripping or other seals, balances, and the like, as is well-known.

The vent is pivotally mounted in the window frame 12, such as by one or more leaf hinges or multi-bar linkage hinges (also known as “friction stays”). The hinges 16 may allow pivotal movement of the window vent 14 relative to the window frame 12 to open and close the window. An exemplary multi-bar hinge assembly is disclosed in U.S. Pat. No. 7,690,154 entitled, “Channel-Mounted 4-Bar Linkage Assembly,” the disclosure of which is incorporated herein by reference in its entirety and in International Application Publication No. WO 2021/257291 A1 entitled, “High-Capacity Multi-Bar Linkage Assembly For Pivotally Mounted Window Vent,” the disclosure of which is incorporated herein by reference in its entirety.

The vent operator 18 is installed in the base frame 28 of the window frame and is operable to move the window vent between the opened and closed positions. For example, a handle 36 of the vent operator 18 is operably coupled to an actuator including an arm connected to the window vent. Rotating the handle 36 can operate a drive mechanism to open and close the window vent. Additionally, the vent operator 18 may also engage the window locking system 20 to lock and unlock the vent relative to the window frame. An exemplary vent operator 18 is disclosed in U.S. Pat. No. 10,309,144 entitled, “Vent Operator,” the disclosure of which is incorporated herein by reference in its entirety.

The window locking system 20 provides for multiple lock points for the window to be located about the perimeter of and/or on more than one side of the window frame 12. The window locking system 20 is operably coupled to and engaged and disengaged by the window operator through a drive component (e.g., lock bar (FIG. 2)). The window locking system 20 providing multiple lock points (e.g., lock pins 38) is desirable and advantageous to improve the window assembly's resistance to wind and water infiltration and/or improve the window's design pressure (DP) rating.

Turning more specifically to FIGS. 2, 3 and 4, the corner drive assembly 22 of the present disclosure is illustrated in greater detail. The corner drive assembly 22 is included as part of the window locking system 20 and operably engages the drive and/or lock components of the window locking system 20. The corner drive assembly 22 functions to transfer the linear motion of the locking system drive and/or lock components in one direction (e.g., along a horizontal axis) to linear motion of other locking system drive and/or lock components in another direction (e.g., along a vertical axis) and vice versa.

The corner drive assembly 22 may be installed or attached to the window frame 12 (e.g., to the horizontal base frame and a vertical side jamb). The corner drive assembly 22 can be mounted to the window frame 12 in different configurations with fasteners 58, 86a as will be described further herein.

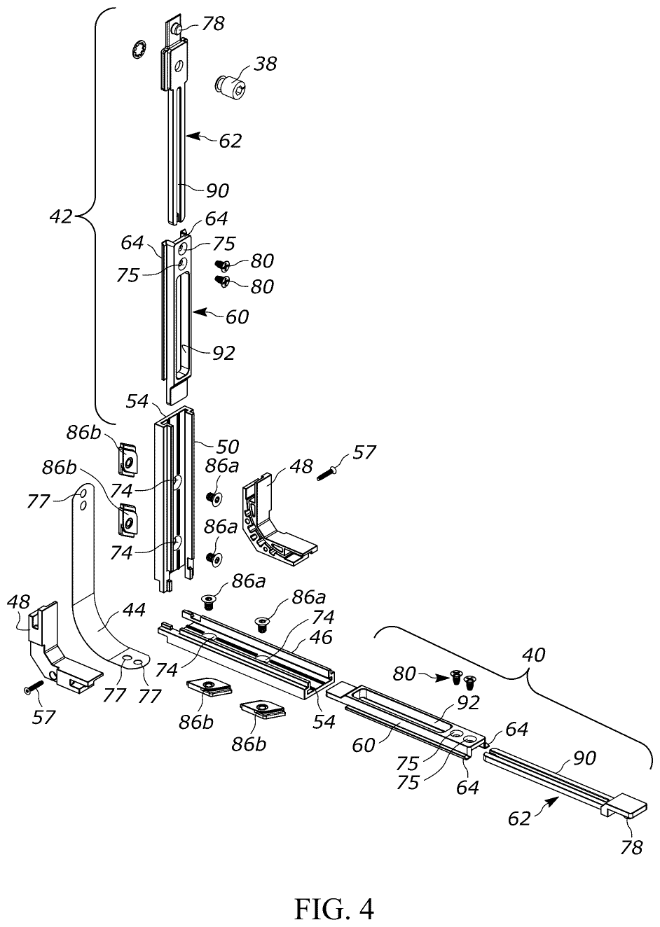

Referring to the exploded view shown in FIG. 4, the corner drive assembly 22 of the present disclosure can be readily understood. Generally, the corner drive assembly 22 includes a lower adjustment arm 40, a body (or case), a transfer spring 44 and an upper adjustment arm 42. The body of the corner drive assembly 22 provides an installation interface for mounting the corner drive assembly 22 to the window frame 12. The body also carries the transfer spring 44 and the lower and upper adjustment arms 40, 42 which translate relative to the body upon operation of the window locking system 20.

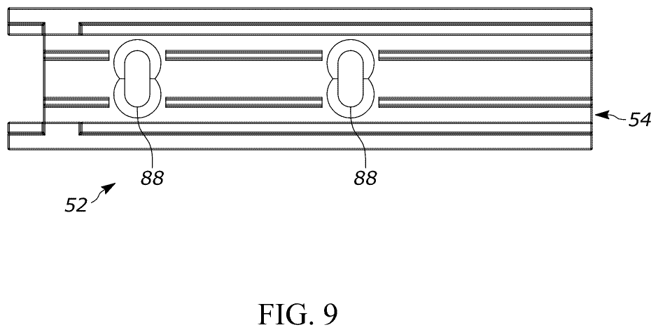

The body of the corner drive assembly 22 generally includes a lower drive track 46, a corner section 48, and an upper drive track 50. The lower and upper drive tracks 46, 50 can be substantially identical. With additional reference to FIG. 9, each drive track 46, 50, 52 is shown as being generally rectangular and extending along and symmetrical about central longitudinal axis from a distal end to a proximal end. The drive tracks 46, 50, 52 provide a longitudinally extending upwardly opening channel 54, for receiving the adjustment arm in a telescopically, sliding and/or nesting relationship. The drive tracks 46, 50, 52 exhibit an upwardly open cross-section defined by a lower wall, two opposing side walls each extending upwardly from an opposite lateral side of the bottom wall, and two opposing upper wall segments each offset from the bottom wall and each extending inwardly from the opposing side walls. The upper sides of the drive tracks 46, 50, 52 provide an upper opening or pass through that is defined by the terminal ends of the upper wall segments. The lower wall of the drive tracks 46, 50, 52 includes one or more mounting apertures 74, 88 to accommodate fasteners 58, 86a for installing and attaching the corner drive assembly 22 to the window frame 12.

The corner section 48 of the body joins the lower drive track 46 with the upper drive track 50 and generally surrounds a central portion of the transfer spring 44. The corner section 48 of the body is shown as having two parts or lateral halves which are fastened together (e.g., with fasteners 57) and house the transfer spring 44. The corner section 48 includes an interior curved bearing surface or series of bearing surfaces aligned along a curve and extending through or substantially through the corner section 48. The transfer spring 44 can slide back and forth over and/or along the bearing surface as the corner drive assembly 22 redirects the linear motion of the adjustment arms around a corner of the window frame 12. The bearing surface can exhibit a preferred or desirable coefficient of friction to enable the transfer spring 44 to slide smoothly and evenly along the bearing surface, contributing to operation of the window locking system 20 to responsive to an operating force within a desired range. Additionally, a lubricant, such as polytetrafluoroethylene (“PTFE”), may be disposed on the bearing surface.

Connecting features are provided at the lower and upper ends of the corner section 48 to facilitate attachment of the corner section 48 to the proximal ends of the lower and upper drive tracks 46, 50, respectively. The connecting features can, e.g., include mating male/female “snap-fit”-type connectors or other conventional connection features. When attached, the channel 54 of the lower drive track 46 and the channel 54 of the upper drive track 50 are each generally aligned with the bearing surface.

The transfer spring 44 extends through and beyond lower and upper ends of the corner section 48. The transfer spring 44 attaches, respectively, to the proximal ends of the lower and upper adjustment arms 40, 42, as further discussed herein. Housed within the corner section 48 and slidable along the bearing surface, the transfer spring 44 is operable to transfer the force exerted on one adjustment arm to the other adjustment arm without buckling. In one example, the transfer spring 44 may be a thin strip of metal tape comprising steel or stainless steel and be 0.0105 inches thick and 0.715 inches wide.

The lower and upper adjustment arms 40, 42 of the corner drive assembly 22 extend outward from the distal ends of the lower and upper drive tracks 46, 50, respectively. Each of the lower and upper adjustment arms 40, 42 is received by the lower and upper drive tracks 46, 50 in a telescopically, sliding and/or nesting relationship. The lower and upper adjustment arms 40, 42 are connected to one another by way of the transfer spring 44 and move or slide relative to the body responsive to operation of the window locking system 20.

The lower and upper adjustment arms 40, 42 of the corner drive assembly 22, themselves, are similarly constructed and each include an outer adjustment bar 60 and an inner adjustment bar 62. The outer adjustment bar 60 receives the inner adjustment bar 62 in a telescopically, sliding and/or nesting relationship.

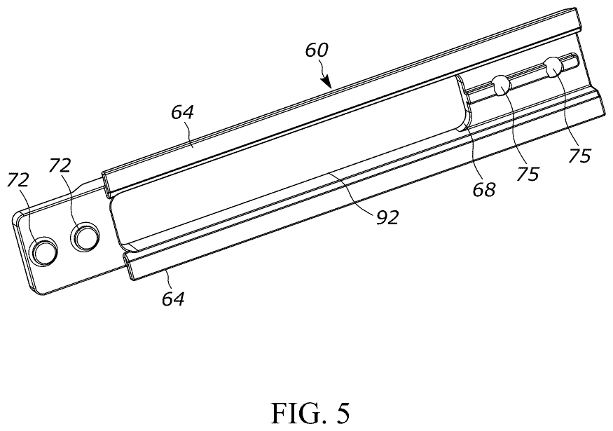

The outer adjustment bar 60 (see, e.g., FIGS. 4 and 5) is generally rectangular and extends from a proximal end to a distal end along a longitudinal axis generally colinear with the longitudinal axis of the drive track 52. The outer adjustment bar 60 is generally symmetrical about the longitudinal axis. The outer adjustment bar 60 exhibits a downwardly open cross-section defined by an upper wall, two opposing side walls each extending downwardly from an opposite lateral side of the upper wall. Additionally, the outer adjustment bar 60 includes two longitudinally extending side rails 64. Each side rail 64 extends from a lower end of a respective side wall and projects laterally outwardly from the longitudinal axis of the outer adjustment bar 60. The upper wall of the outer adjustment bar 60 includes an access opening or pass through 92 extending through a portion of the upper wall. Another portion of the upper wall near the distal end of the outer adjustment bar 60 includes one or more apertures 75 to accommodate fasteners 80 which are employed to secure the outer adjustment bar 60 to the inner adjustment bar 62.

With particular reference to FIG. 5, on a lower side of the upper wall of the outer adjustment bar 60 that is opposite to the one or more apertures 75, a stiffening rib 68 is provided. The one or more apertures 75 extend through the stiffening rib 68. The stiffening rib 68 is relatively long and narrow and extends lengthwise in a direction of the longitudinal axis of the outer adjustment bar from the distal end toward the proximal end of the outer adjustment bar 60. The stiffening rib 68 has a preferred lateral width and a vertical depth. The stiffening rib 68 increases the amount of material in the upper wall within the vicinity of the one or more apertures 75 to provide more material for the fasteners 80 to engage as the fasteners 80 are employed to join the outer adjustment bar 60 and inner adjustment bar 62. This, in turn, helps keep the fasteners 80 properly oriented during installation so that the fasteners 56 may be installed correctly and easily.

Still referring to FIG. 5, near the proximal end of the outer adjustment bar 60 opposite of the stiffening ribs 68, the lower side of the upper wall provides one or more mounting bosses 72. The mounting bosses 72 are cooperable with the corresponding attachment apertures 77 of the transfer spring 44. The mounting bosses 72 can engage the apertures 77 of the transfer spring 44 and thereafter be peened, staked or otherwise deformed to create an interference fit with the apertures 77 to thereby fasten the outer adjustment bar 60 to the transfer spring 44.

Referring now to FIGS. 4, 7 and 8, the inner adjustment bar 62 is more particularly illustrated. The inner adjustment bar 62 is generally rectangularly shaped and extends along a longitudinal axis from a proximal end to a distal end. The inner adjustment bar 62 is generally symmetrical along the longitudinal axis. The inner adjustment bar 62 includes a long, narrow slot 90 extending longitudinally for a substantial portion of the length of the inner adjustment bar 62. The slot 90 has a width substantially narrower than its length and the slot 90 is centered along the longitudinal axis of the inner adjustment bar 62. The slot 90 passes entirely through a vertical depth of the inner adjustment bar 62. The slot 90 extends substantially to the proximal end of the inner adjustment bar 62.

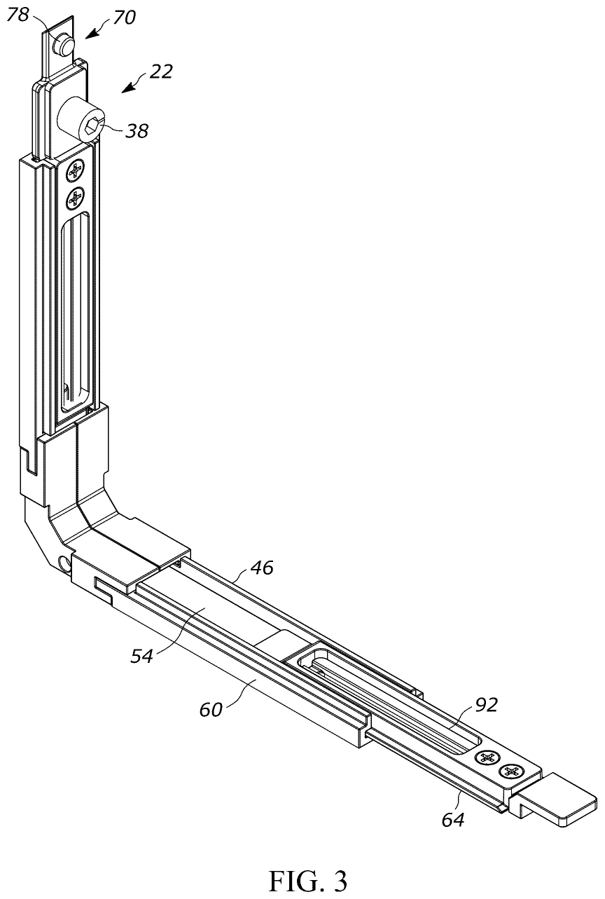

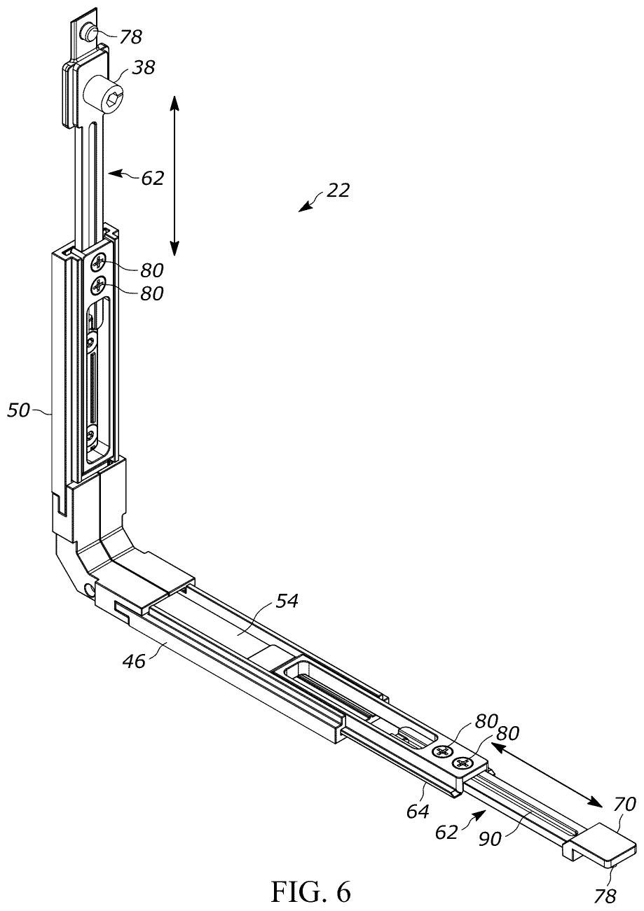

The inner adjustment bar 62 terminates at the distal end. Included at the distal end of the inner adjustment bar 62 may be a coupling member 70 (e.g., see FIGS. 3 and 6). The coupling member 70 can be configured to join to a lock bar 76 of the window locking system 20 to thereby integrate the corner drive assembly 22 into the window locking system 20. The coupling member 70 can include a feature for joining the inner adjustment bar 62 to the lock bar 76, such as a boss or pin 78, that is configured to engage with a counterpart opening or aperture in the lock bar 76.

In another aspect, the distal end can alternatively or additionally include a lock pin 38 for the window locking system 20, as seen in FIGS. 2 and 6, for example. The lock pin 38 can be cooperable with and engage a keeper 81 on the window vent 14 (FIG. 1) to provide a lock point for the window assembly that is locked and unlocked by the window locking system 20.

As can be understood from the figures, and particularly FIGS. 4, 7 and 8, the outer adjustment bar 60 telescopingly, slidingly and/or nestingly receives the inner adjustment bar 62. In this regard, the stiffening rib 68 of the outer adjustment bar 60 is aligned with and received in the slot 90 of the inner adjustment bar 62 and the inner adjustment bar 62 is captured in a nesting relationship with the outer adjustment bar 60. The inner and outer adjustment bars 62, 60 are attached to one another by fasteners 80. The fasteners 80 are received in the apertures 75 in the upper wall of the outer adjustment bar 60 and extend through the stiffening rib 68 and then into the slot 90 of the inner adjustment bar 62. The fasteners can be self-tapping screws, that tap into the slot 90, and draw the inner adjustment bar 62 into a fixed relationship with the outer adjustment bar 60.

As seen in FIGS. 6, 7 and 8, it can be further understood that the position of the distal end of the inner adjustment bar 62 relative to the proximal end of the outer adjustment bar 60 is variable (see arrows, FIG. 6). Consequently, the overall length of the adjustment arm assembly is likewise variable. In this respect, the telescoping relative position of the inner adjustment bar 62 to the outer adjustment bar 60 can be selected or established by a user before fastening the outer and inner adjustment bars 60, 62 to one another. As a result, the corner drive assembly 22 of the disclosure enables the overall length of the adjustment arm assembly to be modified to enable the corner drive assembly 22 to be universally integrated with a window locking system 20 and its other components which can vary among different window assemblies, sizes and styles.

For example, the overall length of each adjustment arm assembly can be increased by telescoping or extending the inner adjustment bar 62 further out from the distal end outer adjustment bar 60 prior fastening the inner and outer adjustment bars 62, 60 together. The increase in length can vary from zero increase (i.e., no extension) to a maximum increase (i.e., full extension). The maximum extension can be on the order of several inches or more. In one preferred, non-limiting aspect of the disclosure, the length adjustability of each adjustment arm assembly can vary from zero inches to 2.5 inches (i.e., a combined 5 inches for the lower and upper adjustment arms 40, 42). Still further, there is no preset or fixed increment to the adjustability between the minimum and maximum values. Thus, the corner drive assembly 22 of the disclosure provides infinite adjustability. The capability to provide infinite adjustability of the corner drive assembly 22 (within a range of adjustment) allows the window operator and locking system component sizes to be standardized, thereby reducing the total number of parts and assemblies.

In another aspect of the disclosure, the corner drive components, including the outer and inner adjustment bars 60, 62 of the lower and upper adjustment arms 40, 42 and the body (including the lower drive track 46, the corner section 48 and the upper drive track 50), a transfer spring 44, and lower and upper adjustment arms 40, 42, may comprise metal or plastic. For example, the outer and inner adjustment bars 62, 60 can comprise a zinc alloy and the lower and upper drive tracks 46, 50 can comprise an aluminum alloy. As a further example, the corner section may comprise an acetal or polyoxymethylene (CH₂O)ₙ) plastic, such as an acetal homopolymer or a copolymer, including Delrin®, Celcon®, Ramtal, Duracon®, Kepital®, and Hostaform®, by way of non-limiting example. Preferably, the materials have low coefficients of static friction and/or kinetic friction. For example, in a preferred form, the coefficient of kinetic friction between the bearing surface of corner section 48 and the transfer spring 44 is preferably between about 0.15 and 0.40. Thus, the transfer spring 44 can slide freely along the bearing surface of the corner section 48. Further, the corner drive assembly 22 may include a lubricant disposed on and/or between adjacent sliding components, such as polytetrafluoroethylene (“PTFE”).

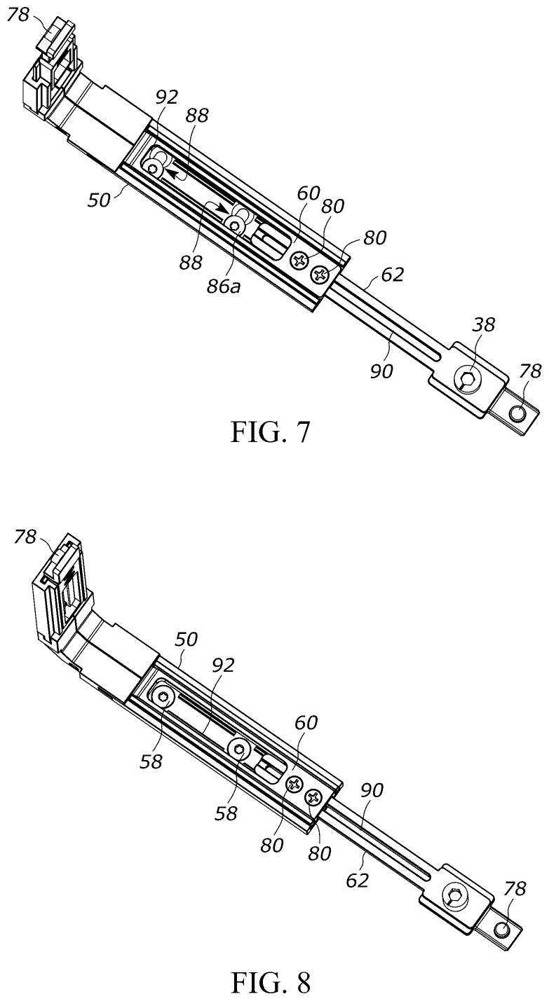

The corner drive assembly 22 is installed in a window frame 12 and integrated with a window locking system 20. The corner drive assembly 22 of the present disclosure is adaptable for a surface mount installation (see FIG. 8) or for a Euro-groove installation (see FIG. 7). In general, mounting fasteners (e.g., machine screws 86a and Euro-nuts 86b (FIGS. 4, 7) or self-drilling and self-tapping screws 58 (FIG. 8)) can attach the corner drive assembly 22 to a window frame 12 (FIG. 2).

With reference to FIG. 8, in a surface mount installation screw fasteners 58 (e.g., self-drilling and self-tapping counter-sink style screws) can attach the corner drive assembly 22, to the base frame 28 and jamb 26 of the window frame 12. For example, at installation, the adjustment arms 40, 42 can be slid out of the way to allow access to the lower walls of the drive tracks 46, 50 through the upwardly opening channel 54 of the drive tracks 46, 50 (alternatively, access can be provided through the access openings 92 in the outer adjustment bars 60 without moving the adjustment arm assemblies). Thereafter the screws 58 can, respectively, be driven through the lower and upper drive tracks 46, 50 of the corner drive assembly 22 and into the base frame 28 and jamb 26 to affix the corner drive assembly 22 to the window frame 12.

In a Euro-groove installation, Euro-nut screws 86a (e.g., having a counter-sink style) with spin-style lock nuts (“Euro-nut”) 86b can attach the lower and upper drive tracks 46, 50 of the corner drive assembly 22 to the window frame 12 including Euro-grooves formed in the base frame 28 and the side jambs 26 of the window frame 12. The Euro-nuts 86b can have a narrow dimension that is smaller than the opening to the Euro-groove (e.g., an upwardly or inwardly open C-channel) and a wide dimension that is larger than the opening to the Euro-groove. The Euro-nuts 86b can be rotated so that the narrow dimension is aligned with opening in the Euro-groove. The Euro-nuts 86b can then enter the Euro-groove. Once received in the Euro-groove, the Euro-nut 86b can be rotated (e.g., via the Euro-nut screws 86a) until the wide dimension of the Euro-nut 86b engages the Euro-groove (e.g., interferes with and bears against opposing side walls of the Euro-groove). Thereafter, continued rotation of the Euro-nut screws 86a, draws the Euro-nut 86b into clamping engagement with, e.g., an upper wall of the Euro-groove, thereby attaching the corner drive assembly 22 to the window frame 12. The Euro-groove mount is advantageous because it does not create any holes through the window frame 12, which require sealing to prevent infiltration of air or moisture.

To facilitate mounting the corner drive assembly 22 to a window frame 12 having a Euro-groove and simultaneously enable the corner drive assembly 22 to mount in either a right-hand corner or a left-hand corner of the window assembly, the drive tracks of the body of the corner drive assembly 22 can include specially adapted mounting apertures 88 (FIG. 9). More particularly, and as best seen in FIGS. 7 and 9, the drive tracks 52 can include a double screw slot 88. The double-screw slot 88 allows the flexibility for the Euro-nut screws 86a to be installed on the left or right side of the longitudinal centerline of the drive track 52 as needed depending on an offset location of the Euro-groove in the window frame 12.

In a pre-installation assembly of the corner drive, the screws 86a can be initially placed through the drive track 52 in either end of the slot 88 and the Euro-nut 86b loosely fastened at a lower side of the drive track 52. Then, the adjustment arm 40, 42 can be assembled into the drive track 52. Upon installation of the corner drive assembly 22 into the window frame 12, the adjustment bars 62 can be slid out of the way to provide access to the screws 86a through the upwardly opening channel 54 of the drive track 52 (alternatively, access can be provided through the access openings 92 in the outer adjustment bars 60 without moving the adjustment arms 40, 42). Then the screws 86a can be moved into the left- or right-side position of the double-screw slot 88 to account for the position of the Euro-groove in the window frame 12 relative to the corner drive assembly 22. The screws 86a can then be rotated to draw the Euro-nuts 86b into engagement with the Euro-groove in the window frame 12.

After the corner drive assembly 22 is installed in the window frame 12, the upper and lower adjustment arms 62 can then be adjusted, as necessary, to attach to lock bars 76 of the window locking system 20. In this respect, the fasteners 80 joining the inner adjustment bar 62 to the outer adjustment bar 60 can be loosened and the inner adjustment bar 62 can be extended, as needed, to enable the coupling member 70 and/or coupling feature 78 to engage with a corresponding lock bar 76 of the window locking system 20. Alternatively, or in addition, adjustment can be made to appropriately position a lock pin 38 of the inner adjustment bar 62 relative to a keeper 81 in the window vent 14. Thereafter, the fasteners 80 can be retightened so as to fix the position of the inner adjustment bar 62 relative to the outer adjustment bar 60. Because the length adjustability of the adjustment arm 40, 42 is infinitely variable (within the adjustment range) the corner drive assembly 22 can be precisely integrated into the window locking system 20 without modifying or changing other components of the window locking system 20 or window operator.

The present disclosure provides a corner drive assembly 22 for integration with a window locking system 20 and installation in a projection-style or a casement-style window assembly and which is co-operable with a vent window operator 18. The corner drive assembly 22 provides for adjustability and can be modified at installation to enable the corner drive assembly 22 to be integrated with a window locking system 20 and its other components which can vary among different window assemblies, window sizes and window styles.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A corner drive for a locking system for a vent window comprising:
a body configured to be attached to a window frame at a corner of the window frame, the body comprising:
a first drive track substantially aligned with a first axis and defining a first guide channel;
a second drive track substantially aligned with a second axis perpendicular to the first axis and defining a second guide channel; and
a corner section joining the first drive track and the second drive track, the corner section comprising bearing surface aligned with the first guide channel and the second guide channel;
a transfer spring at least partially slidably disposed against the bearing surface and having a first end slidable along the first axis and a second end slidable along the second axis;
a first adjustment arm received in the first guide channel and moveable or slidable along the first axis, the first adjustment arm having a first proximal end coupled to the first end of the transfer spring;
a second adjustment arm received in the second guide channel and moveable or slidable along the second axis, the second adjustment arm having a second proximal end coupled to the second end of the transfer spring;
wherein at least one of (i) a first length of the first adjustment arm is adjustable within a first adjustment range and (ii) a second length of the second adjustment arm is adjustable within a second adjustment range; and
wherein at least one of the first adjustment arm and the second adjustment arm is configured to be coupled to a lock bar of the locking system.

2. The corner drive of claim 1, wherein at least one of the first length of the first adjustment arm and the second length of the second adjustment arm is infinitely adjustable within the first adjustment range and the second adjustment range, respectively.

3. The corner drive of claim 1, wherein the first length of the first adjustment arm is adjustable within the first adjustment range; and
wherein the second length of the second adjustment arm is adjustable within the second adjustment range.

4. The corner drive of claim 3, wherein the first length of the first adjustment arm is infinitely adjustable within the first adjustment range; and
wherein the second length of the second adjustment arm is infinitely adjustable within the second adjustment range.

5. The corner drive of claim 1, wherein at least one of the first adjustment arm and the second adjustment arm comprises:
an outer adjustment bar and an inner adjustment bar;
wherein the outer adjustment bar comprises one of the first proximal end and the second proximal end;
wherein the inner adjustment bar is received in the outer adjustment bar;
wherein the inner adjustment bar is moveable relative to the outer adjustment bar along one of the first axis and the second axis; and
wherein a position of a distal end of the inner adjustment bar relative to the one of the first proximal end and the second proximal end is adjustable.

6. The corner drive of claim 5, wherein the outer adjustment bar comprises a first coupling member attached to one of the first end of the transfer spring and the second end of the transfer spring; and
wherein the inner adjustment bar comprises a second coupling configured to be coupled to the lock bar of the locking system.

7. The corner drive of claim 5, wherein the outer adjustment bar comprises a downwardly open cross-section defined by an upper wall, two opposing side walls each extending downwardly from an opposite lateral side of the upper wall, and two longitudinally extending side rails;
wherein each of the two longitudinally extending side rail extends from a lower end of a respective side wall of the two opposing side walls and projects laterally outwardly from a longitudinal axis of the outer adjustment bar; and
wherein the two longitudinally extending side rails of the outer adjustment bar are telescopingly received in at least one of the first guide channel of the first drive track and the second guide channel of the second drive track.

8. The corner drive of claim 7, wherein the upper wall of the outer adjustment bar comprises an opening extending through a portion of the upper wall;
wherein the upper wall near a distal end of the outer adjustment bar comprises an aperture; and
wherein the corner drive further comprises a fastener disposed through the aperture and fixing the outer adjustment bar to the inner adjustment bar.

9. The corner drive of claim 8, wherein the inner adjustment bar comprises a slot extending along a longitudinal axis of the inner adjustment bar; and
wherein the fastener engages the slot.

10. The corner drive of claim 9, wherein the slot passes through the inner adjustment bar and extends substantially to a proximal end of the inner adjustment bar.

11. The corner drive of claim 9, wherein a lower side of the upper wall of the outer adjustment bar comprises a rib;
wherein the aperture extends through the rib.

12. The corner drive of claim 1, wherein:
the first drive track is configured to be attached to a base frame of the window frame and the second drive track is configured to be attached to side jamb of the window frame.

13. The corner drive of claim 12, further comprising a plurality of Euro-nuts and a corresponding plurality of screws;
wherein each screw of the plurality of screws threadably engages a corresponding Euro-nut of the plurality of Euro-nuts; and
wherein the first drive track and the second drive track are each configured to be attached to the window frame by the plurality of Euro-nuts and the corresponding plurality of screws.

14. The corner drive of claim 1, wherein the corner insert comprises a lubricant and a polymer comprising acetal homopolymer (CH₂O)ₙ).

15. A vent window comprising the window frame, wherein the window frame comprises a head frame, a left side jamb, a right side jamb and a base frame;
a vent operator; and
a window locking system operatively coupled to the vent operator and comprising the corner drive according to claim 1.

16. The vent window of claim 15, wherein the corner drive according to claim 1 is attached to the window frame, wherein the first drive track is attached to the base frame of the window frame and the second drive track is attached to one of the left side jamb and the right side jamb of the window frame.

17. A method for installing a corner drive according to claim 1 in a vent window having a locking system comprising:
attaching the corner drive according to claim 1 at a corner of a window frame of the vent window;
adjusting at least one of the first length of the first adjustment arm and the second length of the second adjustment arm; and
coupling at least one of the first adjustment arm and the second adjustment arm to a lock bar of the locking system.

18. The method of claim 17, wherein the step of adjusting at least one of the first length of the first adjustment arm and the second length of the second adjustment arm comprises adjusting both the first length of the first adjustment arm and the second length of the second adjustment arm.

19. The method of claim 17, wherein the step of attaching the corner drive comprises:
attaching the first drive track to a base rail of the window frame with a first fastener and the second drive track to one of a left side jamb and a right side jamb of the window frame with a second fastener; and
wherein the first fastener and the second fastener comprise one of (i) a machine screw and a Euro-nut and (ii) a self-tapping screw.
